(19) United States
(12) Patent Application Publication
(10) Pub. No.: US 2026/0219443 A1
(43) Pub. Date: Jul. 30, 2026

(54) OPTICAL COMPONENTS INCLUDING A METAMATERIAL STRUCTURE AND METHODS OF FORMING THEREOF

(71) Applicant: GlobalFoundries U.S. Inc., Malta, NY (US)

(72) Inventors: APOORVA VAKIL, Halfmoon, NY (US); ROMAIN FEUILLETTE, Williston, VT (US); DAVID PRITCHARD, Schenectady, NY (US); RYAN SPORER, Mechanicville, NY (US); COLLIN TRANTER, Clifton Park, NY (US); TAKAKO HIROKAWA, Ballston Lake, NY (US); YUSHENG BIAN, Ballston Lake, NY (US)

(21) Appl. No.: 19/036,004

(22) Filed: Jan. 24, 2025

(51) Int. Cl. G02B 6/12; G02B 1/00; G02B 6/13

(52) U.S. Cl. CPC G02B 6/12004; G02B 1/002; G02B 6/13

(57) ABSTRACT

A structure for a photonics chip includes a substrate and an optical component over the substrate. The optical component includes a metamaterial structure, the metamaterial structure including a plurality of elements in series and a dielectric material surrounding the plurality of elements. Each element has a first end surface and a second end surface opposite to the first end surface. The second end surface of each element includes a first end surface portion and a second end surface portion along a lateral position on the second end surface, the second end surface portion having a different orientation from the first end surface portion.

### TECHNICAL FIELD

The present disclosure relates generally to photonics chips, and more particularly to structures for photonic chips and methods of forming such structures.

### BACKGROUND

Photonics chips are finding applications in a wide range of fields, such as telecommunications, data communications, sensing, medical devices, and quantum computing, as they enable faster, more efficient, and higher capacity information processing and communication. A photonics chip, also known as an integrated photonics chip or photonic integrated circuit (PIC), is a semiconductor device that integrates various optical components and functions on a single chip or substrate. For example, passive optical components, such as waveguides which may be employed to guide light within the chip, may be integrated with active components such as lasers and detectors in a single chip. Such integration may be complex and pose performance and/or footprint challenges. For example, polarization group delay, insertion loss, optical return loss can affect the efficiency of light transmission, and degrade performance of the devices.

From the foregoing discussion, it is desirable to provide improved structures for a photonics chip and methods of forming thereof.

### SUMMARY

According to various embodiments, a structure for a photonics chip includes a substrate and an optical component over the substrate. The optical component includes a metamaterial structure, the metamaterial structure including a plurality of elements in series and a dielectric material surrounding the plurality of elements. Each element has a first end surface and a second end surface opposite to the first end surface. The second end surface of each element includes a first end surface portion and a second end surface portion along a lateral position on the second end surface, the second end surface portion having a different orientation from the first end surface portion.

In one embodiment, the second end surface of each element defines a protrusion in the second end surface of the element. In another embodiment, the second end surface of each element defines or surrounds a notch in the second end surface of the element. In yet another embodiment, the second end surface of each element defines a protrusion in the second end surface of the element and the first end surface defines a notch in the first end surface of the element.

According to various embodiments, a method of forming a structure is provided. The method includes forming an optical component over a substrate, the optical component including a metamaterial structure. The metamaterial structure includes a plurality of elements formed in series, each element having a first end surface and a second end surface opposite to the first end surface. The second end surface of each element includes a first end surface portion and a second end surface portion along a lateral position on the second end surface, the second end surface portion having a different orientation from the first end surface portion. A dielectric material is formed to surround the plurality of elements.

These and other advantages and features of the embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following:

FIG. 1 is a top view of a structure in accordance with embodiments of the invention;

FIG. 1A is a cross-sectional view of the structure taken generally along line A-A′ in FIG. 1;

FIGS. 2 to 8 illustrate top views of the structure in accordance with other various embodiments of the invention;

FIG. 9 illustrates a top view of a plurality of elements of a metamaterial structure in accordance with various embodiments of the invention;

FIG. 10 illustrates a cross-sectional view of the structure in accordance with another embodiment of the invention;

FIG. 11 illustrates a top view of another structure in accordance with various embodiments of the invention;

FIG. 11A shows cross-sectional views of the structure taken generally along line A-A′ and B-B′ in FIG. 11, respectively; and

FIG. 11B is a side view of the structure in FIG. 11.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the embodiments. Other embodiments may be utilized and structural, logical, and electrical changes may be made without departing from the scope of the invention. The various embodiments are not necessarily mutually exclusive, as some embodiments can be combined with one or more other embodiments to form new embodiments.

Aspects of the present invention and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

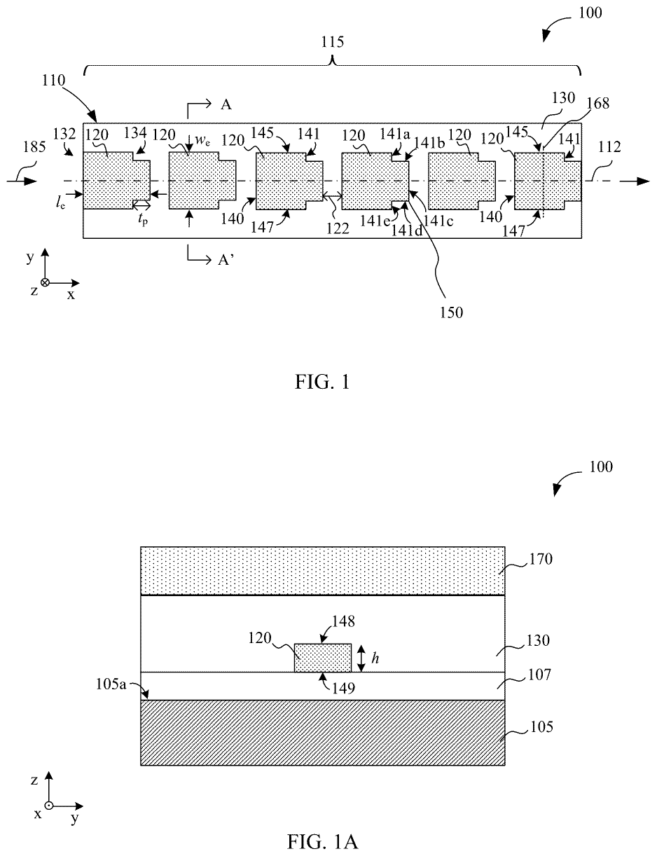

FIG. 1 and FIG. 1A illustrate top and cross-sectional views of a structure 100, respectively, in accordance with various embodiments of the invention. The structure 100 includes an optical component 110 arranged over a substrate 105. The substrate 105 may be a semiconductor substrate. The substrate 105 may be formed of a semiconductor material, such as single-crystal silicon. A dielectric layer 107 may be arranged between the optical component 110 and the substrate 105. In one embodiment, the dielectric layer 107 may be formed of a dielectric material, such as silicon dioxide. The dielectric layer 107 may separate the optical component 110 from the substrate 105 and may provide low-index cladding for the optical component 110. In one embodiment, the dielectric layer 107 may be a buried oxide layer of a silicon-on-insulator substrate.

In one embodiment, the optical component 110 may be a passive photonic component. The optical component 110 may be configured to transfer light. The optical component 110 may include, or may be formed of, a metamaterial structure 115. The metamaterial structure 115 includes a plurality of elements 120 arranged over the substrate 105 and a dielectric material 130 surrounding the plurality of elements 120. The elements 120 of the metamaterial structure 115 may be formed of a material having a refractive index that is greater than the refractive index of the dielectric material 130. In one embodiment, the dielectric material 130 may be silicon dioxide, and the elements 120 of the metamaterial structure 115 may be comprised of a material having a refractive index that is greater than the refractive index of silicon dioxide. In one embodiment, the elements 120 of the metamaterial structure 115 may be formed of a semiconductor material, such as single-crystal silicon. In another embodiment, the elements 120 of the metamaterial structure 115 may be formed of a dielectric material, such as silicon nitride, silicon oxynitride, or aluminum nitride. In other embodiments, the elements 120 of the metamaterial structure 115 may be formed of a III-V compound semiconductor.

The elements 120 of the metamaterial structure 115 may be arranged along the direction of light propagation. Referring to FIGS. 1 to 8, the elements 120 may be arranged in series. In one embodiment, the elements 120 may be arranged in a lateral direction over the substrate 105. For example, FIGS. 1 to 8 illustrate the elements 120 arranged in series along the x-axis over the substrate 105. The elements 120 may be configured to transfer light to one another consecutively. As illustrated in FIGS. 1, 2, 3, 4, 5, 6, 7 and 8, each element 120 of the metamaterial structure 115 has a first end 132 and a second end 134 opposite to the first end 132. Each element 120 may include a first end surface 140 at the first end 132 and a second end surface 141 at the second end 134. Each element 120 of the plurality of elements 120 may be arranged in series with the second end surface 141 of a first element 120 of a pair of immediately adjacent elements 120 facing the first end surface 140 of a second element of the pair. In one embodiment, the first end surface 140 of each element 120 may be a light input surface while the second end surface 141 may be a light output surface. In use, light may propagate from the first end surface 140 to the second end surface 141 of each element 120. For example, for each pair of immediately adjacent elements 120, the second end surface 141 of a first element of the pair is configured to transfer light to the first end surface 140 of a second element of the pair.

Each element 120 of the metamaterial structure 115 includes opposite side surfaces 145 and 147 connecting the first end surface 140 to the second end surface 141. Each of the elements 120 further includes top and bottom surfaces 148 and 149 defining a height dimension h of the element 120.

Referring to FIG. 1, the second end surface 141 of each element 120 includes a protrusion 150 that extends from an end portion of the second end surface 141. For example, the protrusion 150 may extend relative to end surface portion 141a and end surface portion 141e of the second end surface 141. In one embodiment, the second end surface 141 of each of element 120 may include end surface portions 141b, 141c, 141d that define the protrusion 150. The protrusion 150 may extend through a full thickness or height h of the element 120 in a direction orthogonal to the lateral direction of the elements 120. For example, the protrusion 150 may extend through a full height h of the element 120 in a direction orthogonal to substrate surface 105a (e.g., along the z-axis). The end surface portion 141c may adjoin the end surface portion 141b and the end surface portion 141d. In one embodiment, the end surface portions 141b, 141d may be planar. In one embodiment, the end surface portions 141b, 141d may be substantially parallel to each other. The end surface portion 141c may also be planar such that the end surface portion 141c is oriented at right angles to each of the end surface portions 141b, 141d. In other embodiments, the end surface portions 141b, 141c, 141d may be planar and the end surface portions 141b, 141d may be slanted at respective obtuse angles relative to the end surface portion 141c. In another embodiment, the end surface portions 141b, 141d may be planar and the end surface portion 141c may be curved. In yet another embodiment, the end surface portions 141b, 141d may be curved and the end surface portion 141c may be planar. In one embodiment, the end surface portions 141b and 141c and the end surface portions 141c, 141d may adjoin at sharp corners. In another embodiment, the end surface portions 141b and 141c and the end surface portions 141c, 141d may adjoin at rounded corners. By providing rounded corners at the second end surface 141 of the element 120, the optical mode of the elements 120 and accordingly the metamaterial structure 115 may be tuned, advantageously providing the desired effective index of refraction of the metamaterial structure 115 and accordingly the effective index of refraction of the optical component 110.

In one embodiment, the end surface portion 141a and the end surface portion 141e may be planar. In another embodiment, the end surface portion 141a and the end surface portion 141e may be curved. In other embodiments, the end surface portion 141b of each element 120 may intersect the side surface 145 forming an edge extending along the height h of the element 120 (e.g., along the z-axis) and the end surface portion 141d may intersect the side surface 147 forming another edge extending along the height h of the element 120 (e.g., along the z-axis), such that end surface portion 141a and the end surface portion 141e are absent.

Accordingly, various embodiments as described provide a plurality of the elements 120 of the metamaterial structure 115 each having a second end surface 141 which includes at least a first end surface portion and a second end surface portion along a lateral position (e.g., along the y-axis) on the second end surface 141 such that the second end surface portion has a different orientation from the first end surface portion. The first end surface 140 of each element 120, in one embodiment, may be substantially flat, for example from the side surface 145 to the side surface 147.

In one embodiment, the elements 120 may be aligned along a longitudinal axis 112 of the metamaterial structure 115. For example, the longitudinal axis 112 of the metamaterial structure 115 may be defined along a longest dimension (e.g., lengthwise) of the metamaterial structure 115. In one embodiment, the longitudinal axis 112 may intersect each of the first end surface 140 and the second end surface 141 of each element 120 of the metamaterial structure 115. In one embodiment, the longitudinal axis 112 may be along the direction of light propagation.

In one embodiment, the end surface portion 141c may be planar and may be oriented transverse to the longitudinal axis 112. In one embodiment, each element 120 and its respective protrusion 150 may be centered about the longitudinal axis 112. In other embodiments, the protrusion 150 of each element 120 may be asymmetrical about the longitudinal axis 112 of the metamaterial structure 115. Accordingly, the second end surface 141 of each element 120 may include at least a first end surface portion and a second end surface portion having a different orientation from the first end surface portion relative to the longitudinal axis 112 of the metamaterial structure 115. Additionally, or alternatively, the second end surface 141 of each element 120 may include at least a first end surface portion and a second end surface portion having a different orientation from the first end surface portion relative to a reference plane 168 between the first end surface 140 and the second end surface 141. The reference plane 168 may be orthogonal to a top surface of the substrate 105.

In one embodiment, the plurality elements 120 may be separated by a plurality of gaps 122 and the dielectric material of the dielectric layer 130 is positioned in the gaps between adjacent pairs of the plurality of elements 120. In one embodiment, the spacing or dimension of the gaps 122 between adjacent elements 120 may be uniform. In another embodiment, the spacing or dimension of the gaps 122 between adjacent elements 120 may vary, for example, decrease in the direction of light propagation. In one embodiment, the pitch and duty cycle of the elements 120 may be uniform to define a periodic arrangement. In other embodiments, the pitch and/or the duty cycle of the elements 120 may be apodized (i.e., non-uniform) to define an aperiodic arrangement.

In one embodiment the optical component 110 may be an optical waveguide.

A back-end-of-line stack 170 may be formed over the optical component 110. The back-end-of-line stack 170 may include dielectric layers that are comprised of a dielectric material, such as silicon dioxide, silicon nitride, tetraethylorthosilicate silicon dioxide, or fluorinated-tetraethylorthosilicate silicon dioxide.

The elements 120 and the dielectric material of the dielectric layer 130 in the gaps 122 between adjacent pairs of elements 120 and surrounding the elements 120 may define the metamaterial structure 115 in which the material constituting the elements 120 has a higher refractive index than the dielectric material of the dielectric layer 130. The metamaterial structure 115 can be treated as a homogeneous material having an effective refractive index that is intermediate between the refractive index of the material constituting the elements 120 and the refractive index of the dielectric material constituting the dielectric layer 130. According to various embodiments, the geometric shape of the end surfaces (e.g., the first end surface 140 and/or the second end surface 141) of the elements 120 may be configured to tune the optical mode of the elements 120 which advantageously provide the desired effective index of refraction of the metamaterial structure 115. Accordingly, the effective index of refraction of the optical component 110 may be configured to reduce the optical return loss for light propagating in devices. In some cases, configuring the shape profile of the end surfaces of the elements 120 of the metamaterial structure 115 to provide the desired mode properties of the elements 120 may reduce transverse-electric (TE) and transverse-magnetic (TM) polarized modes time or group delay for waveguides and long passive optical components may be reduced according to various embodiments. Various embodiments may further improve mode matching during optical transmission or propagation of electromagnetic waves in the metamaterial structure 115 of the optical component 110.

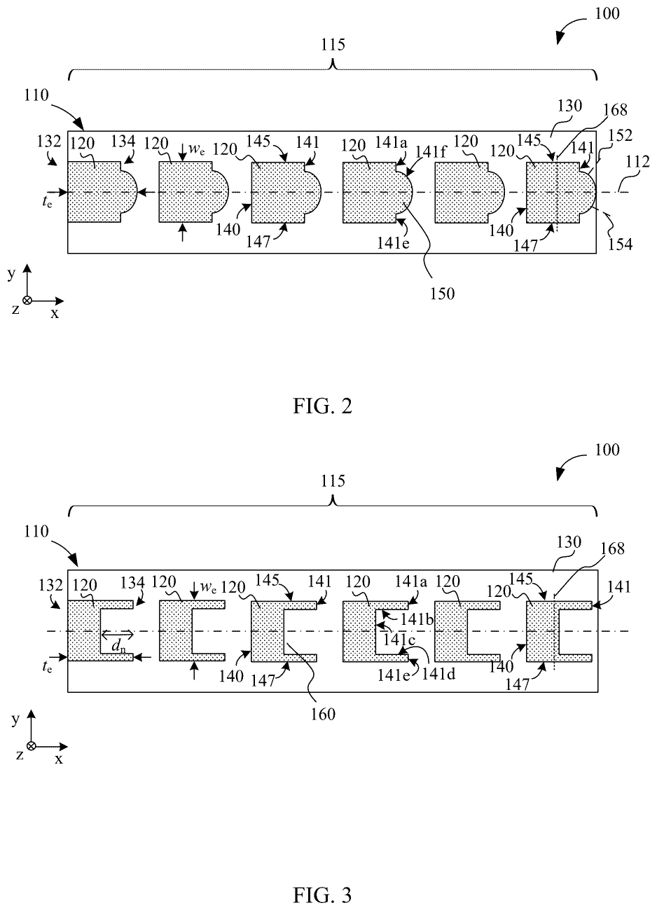

Referring to FIG. 2, in another embodiment, the protrusion 150 may be defined by an end surface portion 141f which is curved. In one embodiment, the end surface portion 141f may be curved with a convex shape. The end surface portion 141f may be continuous and may adjoin the end surface portion 141a and the end surface portion 141e of the second end surface 141. The end surface portion 141a and the end surface portion 141e of the second end surface 141 may be planar. In other embodiments, the end surface portion 141f of the second end surface 141 may intersect the side surface 145 forming an edge extending along the height h and intersect the side surface 147 forming another edge extending along the height h. In such cases, the end surface portion 141a and the end surface portion 141e are absent. In one embodiment, the second end surface 141 may include at least two portions, such as portion 152 and portion 154 along a lateral position on the second end surface 141 having different orientations. For example, the portion 154 may be lateral to the portion 152 of the second end surface 141 and may be inclined at different inclination angles relative to the longitudinal axis 112 of the metamaterial structure 115. For example, the portion 154 may be lateral to the portion 152 of the second end surface 141 and may be inclined at different inclination angles relative to the respective reference plane 168 of the element 120. For example, the portion 154 of the second end surface 141 may be inclined at an acute angle relative to the reference plane 168 and the portion 152 of the second end surface 141 may be inclined at an obtuse angle relative to the reference plane 168.

In another embodiment, the second end surface 141 of each element 120 includes a notch 160 that extends into the second end surface 141, as illustrated in FIG. 3. For example, the second end surface 141 of each element 120 includes a notch 160 that extends into the element 120 relative to the end surface portion 141a and the end surface portion 141e of the second end surface 141. In one embodiment, the second end surface 141 of each of element 120 may include end surface portions 141b, 141c, 141d that define the notch 160 and an area of the dielectric material 130 inside the boundary of the notch 160. The notch 160 may extend through the full thickness or height h of the element 120 in a direction orthogonal to the lateral direction. The end surface portion 141c may adjoin the end surface portion 141b and the end surface portion 141d. In one embodiment, the end surface portions 141b, 141d may be planar. In one embodiment, the end surface portions 141b, 141d may be substantially parallel to each other. The end surface portion 141c may also be planar such that the end surface portion 141c is oriented at right angles to each of the end surface portions 141b, 141d. In other embodiments, the end surface portions 141b, 141c, 141d may be planar and the end surface portions 141b, 141d may be slanted at respective obtuse angles relative to the end surface portion 141c. In another embodiment, the end surface portions 141b, 141d may be planar and the end surface portion 141c may be curved. In yet another embodiment, the end surface portions 141b, 141d may be curved and the end surface portion 141c may be planar. In one embodiment, the end surface portions 141b and 141c and the end surface portions 141c, 141d may adjoin at sharp corners. In another embodiment, the end surface portions 141b and 141c and the end surface portions 141c, 141d may adjoin at rounded corners. In one embodiment, the second end surface 141 of each element 120 may have a first segment defining a prong that is disposed between the notch 160 and an adjacent portion of the side surface 145 and a second segment defining another prong that is disposed between the notch 160 and an adjacent portion of the side surface 147. In other words, the second end surface 141 may be bifurcated to provide segments that terminate prongs separated by the notch 160. The first and second segments of the second end surface 141 may be planar. In another embodiment, the first and second segments of the second end surface 141 may be curved. The first end surface 140 of each element 120, in one embodiment, may be substantially flat.

Similar to the structure 100 described with respect to FIG. 1, in one embodiment, the plurality of elements 120 may be aligned along the longitudinal axis 112 of the metamaterial structure 115 and the longitudinal axis 112 may intersect each of the first end surface 140 and the second end surface 141 of each element 120. In one embodiment, the end surface portion 141c may be planar and may be oriented transverse to the longitudinal axis 112. In one embodiment, each element 120 and its respective notch 160 may be centered about the longitudinal axis 112.

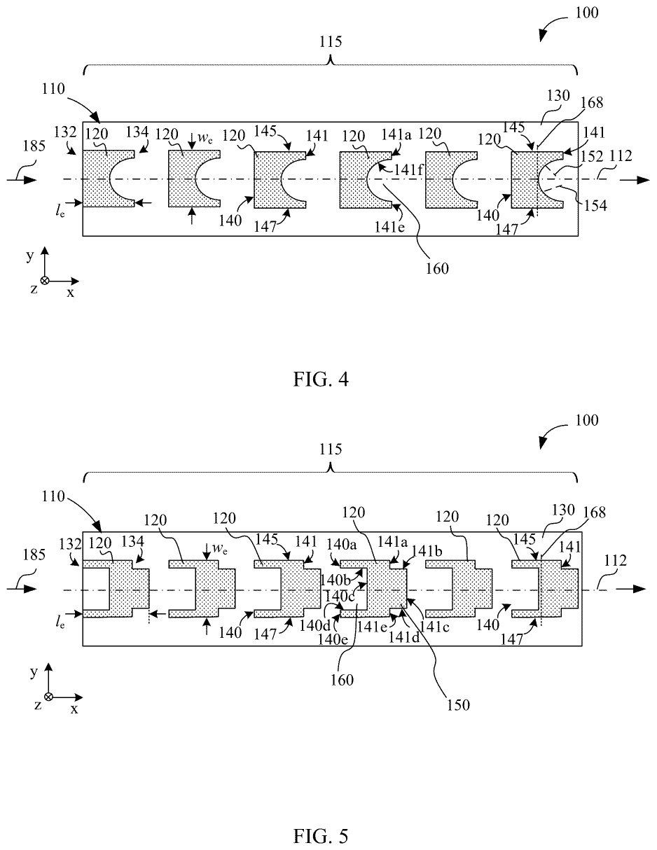

Referring to FIG. 4, in another embodiment, the notch 160 may be defined by end surface portion 141f which is curved. In one embodiment, the end surface portion 141f may be curved with a concave shape. The end surface portion 141f may be continuous and may adjoin the end surface portion 141a and the end surface portion 141e of the second end surface 141. The end surface portion 141a and the end surface portion 141e of the second end surface 141 may be planar. In other embodiments, the end surface portion 141f may intersect the side surface 145 forming an edge extending along the height h and intersect the side surface 147 forming another corner edge extending along the height h. In such cases, the end surface portion 141a and the end surface portion 141e are absent.

In one embodiment, the second end surface 141 may include at least two portions, such as portion 152 and portion 154 along a lateral position on the second end surface 141 having different orientations. For example, the portion 154 may be lateral to the portion 152 of the second end surface 141 and may be inclined at different inclination angles relative to the longitudinal axis 112 of the metamaterial structure 115. For example, the portion 154 may be lateral to the portion 152 of the second end surface 141 and may be inclined at different inclination angles relative to the respective reference plane 168 of the element 120. For example, the portion 154 of the second end surface 141 may be inclined at an obtuse angle relative to the reference plane 168 and the portion 152 of the second end surface 141 may be inclined at an acute angle relative to the reference plane 168.

In another embodiment, the first end surface 140 of each element 120 may include at least a first end surface portion and a second end surface portion along a lateral position (e.g., along the y-axis) on the first end surface 140 such that the second end surface portion has a different orientation from the first end surface portion, instead of being substantially flat. For example, the second end surface portion may be lateral to the first end surface portion of the first end surface 140 and may be inclined at different inclination angles relative to the longitudinal axis 112 of the metamaterial structure 115. Additionally, or alternatively, the first end surface portion and the second end surface portion of the first end surface 140 may be inclined at different inclination angles relative to the respective reference plane 168 of the element 120.

In one embodiment, the first end surface 140 of each element 120 may include a notch 160 that extends into the first end surface 140, and the second end surface 141 of each element 120 may include a protrusion 150 that extends from the second end surface 141, as illustrated in FIG. 5. For example, the first end surface 140 of each of element 120 may include end surface portions 140b, 140c, 140d that surround the notch 160 and an area of the dielectric material 130 inside the boundary of the notch 160. In other embodiments, the first end surface 140 of each element 120 may include an end surface portion which may be curved, such as with a concave shape (not shown in FIG. 5).

In one embodiment, the elements 120 of the metamaterial structure 115 may have a constant width dimension wₑ, and a constant length lₑ, as illustrated in FIG. 1 to 5. The length lₑ, of an element 120 may be the distance between the two ends 132 and 134 of an element 120 as measured along the top surface 148 of the element 120. For example, the length lₑ may be measured from a peak or furthest location in the first end surface 140 to a peak or laterally furthest location in the second end surface 141. In one embodiment, the first end surface 140 and the second end surface 141 may have a constant shape profile for all of the element 120 of the metamaterial structure 115. In one embodiment, the profile of the protrusion 150 or the notch 160 may be constant for each of the elements 120. For example, a lateral thickness tₚ of the protrusion 150 for each of the elements 120 may be substantially the same or equal. The lateral thickness tₚ of the protrusion 150 may be measured from the base of the protrusion 150 to a furthest location or peak in the end surface (e.g., second end surface 141) (e.g., illustrated in FIG. 1). In another example, a lateral depth dₙ of the notch 160 for each of the elements 120 may be substantially the same or equal. The lateral depth dₙ of the notch 160 may be measured from the base of the end surface (e.g., second end surface 141) to a deepest location or valley of the notch 160 in the end surface (e.g., illustrated in FIG. 3).

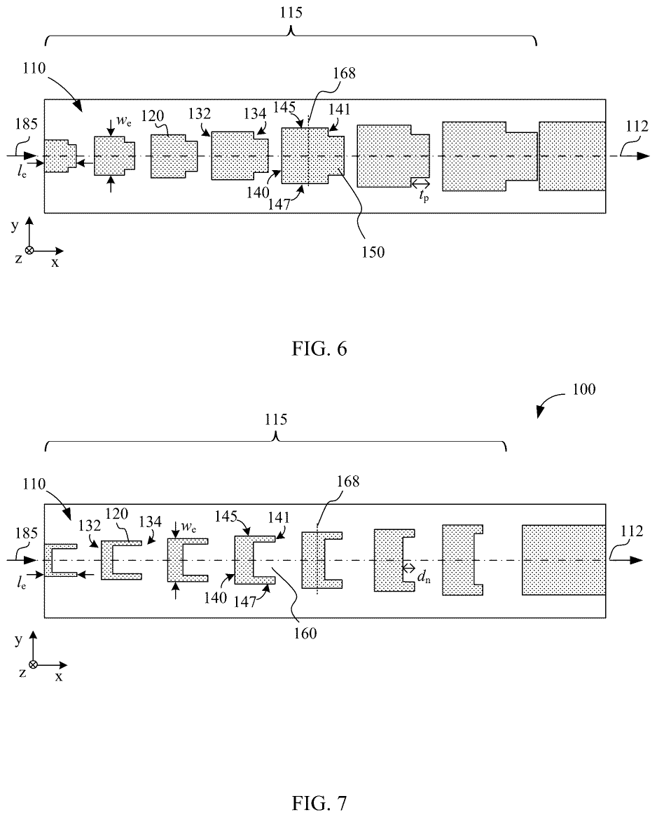

In another embodiment, the elements 120 of the metamaterial structure 115 may have respective width dimensions wₑ that vary, such as increase along the lateral direction or direction of light propagation 185 in the optical component 110 as illustrated in FIG. 6. For example, the optical component 110 may be a taper. The respective width dimensions wₑ of the elements 120 may increase linearly or vary based on a non-linear function, such as a quadratic function, a cubic function, a parabolic function, or an exponential function. In one embodiment, in the case where the optical component 110 is a taper, the elements 120 may include a single stage of tapering characterized by a taper angle. In other embodiments, the elements 120 may taper in multiple stages each characterized by a different taper angle. In yet other embodiments, the elements 120 may be tapered in the height dimension h as well as tapered in the width dimension wₑ. For example, the respective height dimensions h of the elements may vary such as, increase along the lateral direction or direction of light propagation 185.

In another embodiment, the elements 120 of the metamaterial structure 115 may have respective lengths lₑ that vary, such as increase along the lateral direction or direction of light propagation 185 in the optical component 110, as illustrated in FIG. 6. The respective lengths lₑ of the elements 120 may increase linearly or vary based on a non-linear function.

In one embodiment, the elements 120 may have varying shape profile along the lateral direction. In one embodiment, the profile of the protrusion 150 or the notch 160 for each of the elements 120 may vary along the lateral direction or direction of light propagation 185 in the optical component 110. For example, respective lateral thicknesses tₚ of the protrusions 150 for each of the elements 120 may vary, such as increase along the lateral direction or direction of light propagation 185 in the optical component 110 as illustrated in FIG. 6. In another example, respective lateral depths dₙ of the notch 160 for each of the elements 120 may vary, such as decrease along the lateral direction or direction of light propagation 185 in the optical component 110 as illustrated in FIG. 7.

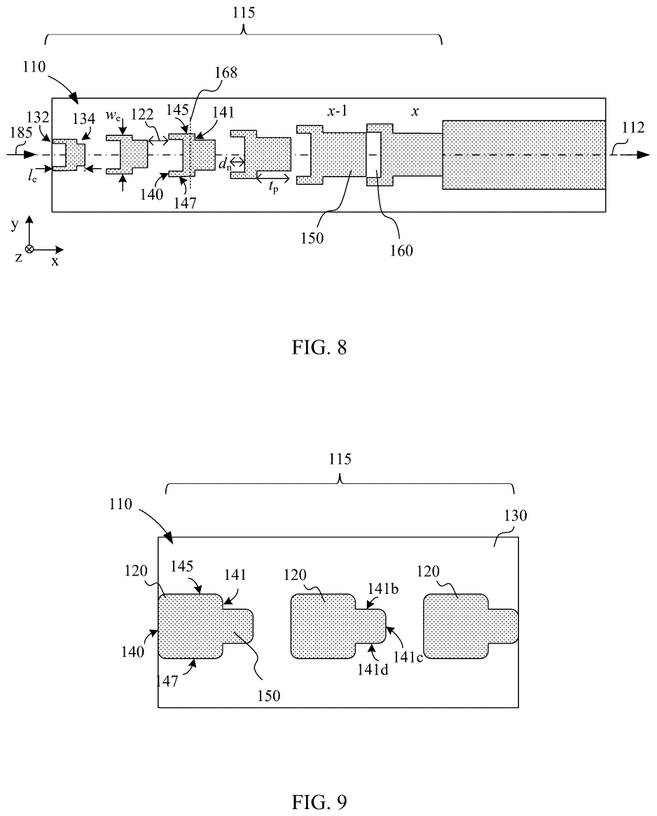

In one embodiment, each of the first end surface 140 and the second end surface 141 of the elements 120 may have varying shape profiles along the lateral direction. In one embodiment, the profile of the protrusion 150 extending from the second end surface 141 of each of the elements 120 and the profile of the notch 160 extending into the first end surface 140 of each of the elements 120 may vary along the lateral direction or direction of light propagation 185 in the optical component 110 (e.g., along the x-axis) as illustrated in FIG. 8. For example, respective lateral thicknesses tₚ of the protrusion 150 in the second end surface 141 of each of the elements 120 may vary, such as increase along the lateral direction or direction of light propagation 185 in the optical component 110. In some embodiments, the lateral depth dₙ of the notch 160 in the first end surface 140 of each of the elements 120 may be the same or equal. In other embodiments, respective lateral depths dₙ of the notch 160 in the first end surface 140 of each of the elements 120 may vary, such as decrease along the lateral direction or direction of light propagation 185 in the optical component 110 (not shown in FIG. 8). In other embodiments, a lateral thickness tₚ of the protrusion 150 in the second end surface 141 of each of the elements 120 may be the same or equal, but respective lateral depths dₙ of the notch 160 in the first end surface 140 of each of the elements 120 may vary, such as increase along the lateral direction or direction of light propagation 185 in the optical component 110.

In one embodiment, the spacing or dimension of the gaps 122 between adjacent elements 120 may be configured to vary in a direction of light propagation. In one embodiment, the spacing of the gaps 122 between the elements 120 may decrease gradually such that the second end surface 141 of a preceding element 120 physically contacts the first end surface 140 of a succeeding element 120 in the series arrangement. For example, as illustrated in FIG. 8, a protrusion 150 in the second end surface 141 of a preceding x-1 element 120 may contact the first end surface 140 of a succeeding x element 120.

In one embodiment, the first end surface 140 may adjoin the side surfaces 145, 147 at rounded corners, and the second end surface 141 may adjoin the side surfaces 145, 147 at rounded corners as illustrated in FIG. 9. In the case that the second end surface 141 has a protrusion 150 extending from the second end surface 141, the protrusion 150 may be defined by end surface portions having rounded corners. For example, the end surface portions 141b and 141c and the end surface portions 141c, 141d of the second end surface 141 may adjoin at rounded corners. In the case that the second end surface 141 has a notch extending into the second end surface 141, the notch may be defined by end surface portions having rounded corners (not shown in FIG. 9). By providing rounded corners where the surfaces adjoin each other, the optical mode of the metamaterial structure 115 may be tuned, advantageously providing the desired effective index of refraction of the metamaterial structure 115 and accordingly configuring the effective index of refraction of the optical component 110.

As described above, the optical component 110 may be an optical waveguide. In other embodiments, the optical component 110, for example, may be a taper, a mode converter, a bend structure, a directional coupler, a multimode interference (MMI) splitter, crossings, or an edge coupler. In the case of optical waveguides, tapers, mode converter, directional coupler, MMI splitter, crossings, and edge couplers, the plurality of elements 120 may be aligned to the longitudinal axis 112 of the metamaterial structure 115. The optical component 110 may include a single-mode waveguide and a multi-mode waveguide. The optical component 110, for example, may couple light from one optical component to another optical component. In another embodiment, the optical component 110 may couple light from a light source to another optical component or to an optical device, such as a photodetector.

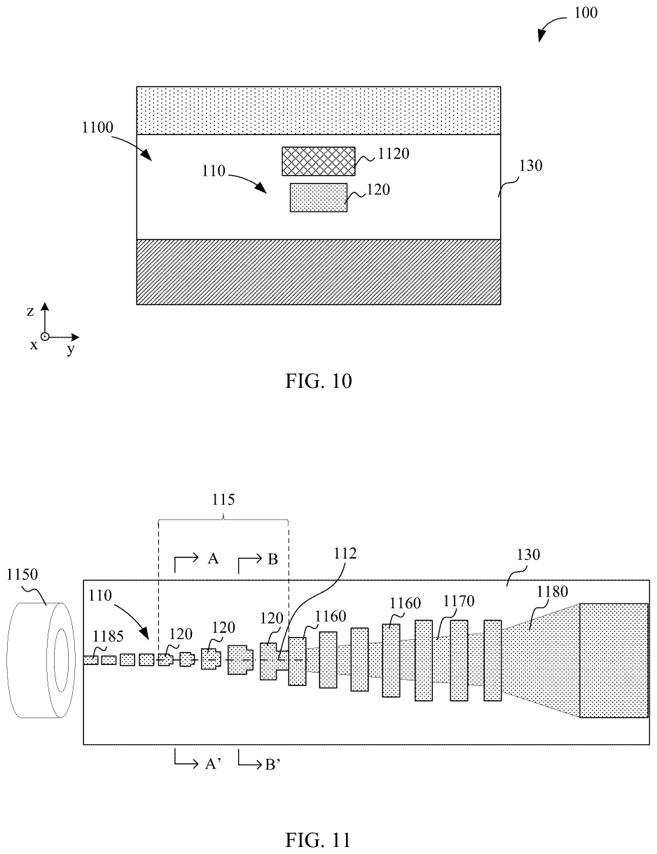

In an embodiment, the metamaterial structure 115 may be included in a stacked optical component. FIG. 10 illustrates a cross-section view another embodiment of structure 100 which includes a stacked optical component 1100. The stacked optical component 1100 may include the optical component 110 including the metamaterial structure 115 having the plurality of elements 120 and a dielectric material 130 surrounding the plurality of elements 120. In one embodiment, the stacked optical component 1100 may further include, for example, a section of another waveguide core 1120 comprised of a different material from the elements 120 of the metamaterial structure 115, such as silicon nitride, that is disposed in a level elevated above the element 120.

The elements 120 of the metamaterial structure 115 may be formed by patterning a layer comprised of its constituent material with lithography and etching processes to form the geometric shape, such as the first end surface 140 and the second end surface 141 of the plurality of elements 120 as described according to various embodiments. In an embodiment, an etch mask may be formed by a lithography process over the layer, and unmasked sections of the deposited layer may be etched and removed with an etching process. The masked sections of the deposited layer may determine the patterned shapes of the elements 120. The gaps 122 between the elements 120 may be filled with the dielectric material 130, for example, by using deposition techniques such as chemical vapor deposition.

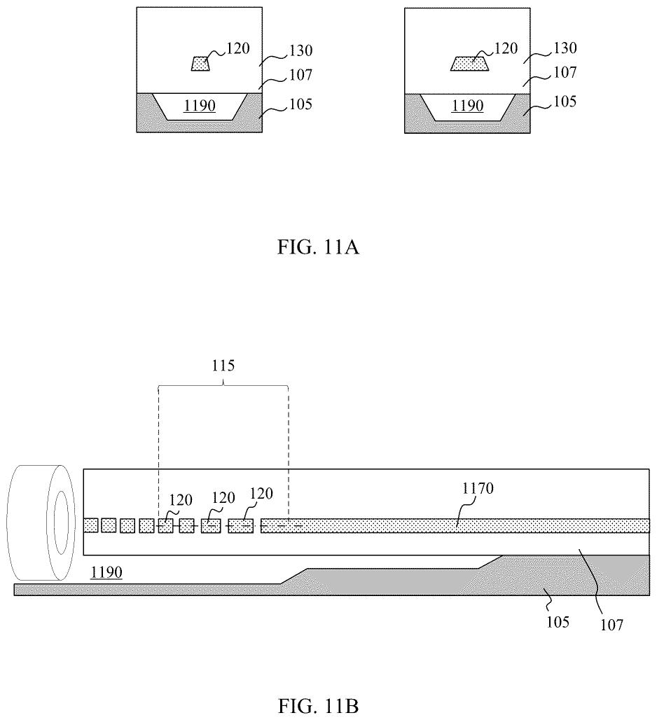

Referring to FIGS. 11, 11A and 11B, in one embodiment, the optical component 110 may be an edge coupler that is positioned at an edge of a photonics chip and adjacent to a light source 1150. The edge coupler may be coupled by a segment of a waveguide core 1180 to a photonic integrated circuit of the photonics chip. In an embodiment, the edge coupler may be configured to receive light from the light source 1150 that is routed by the waveguide core 1180 to the photonic integrated circuit. The light source 1150 may include a light output which may be aligned parallel to the longitudinal axis 112 of the metamaterial structure 115. In one embodiment, the light source 1150 may be an optical fiber that is positioned at the at the edge of the photonics chip adjacent to the plurality of elements 120 of the metamaterial structure 115. In one embodiment, the first end surface 140 of each of the plurality of elements 120 of the metamaterial structure 115 may be facing the light source 1150, while the second end surface 141 may be facing away from the light source 1150. The edge coupler may include segments of waveguide core 1185 which may be aligned along a longitudinal axis 112 of the metamaterial structure 115. The edge coupler may include a plurality of grating structures 1160 and a transition structure 1170 that overlaps with the plurality of grating structures 1160. In one embodiment, the last or terminal element 120 in the series of the plurality of elements 120 may abut a grating structure 1160. The transition structure 1170 may overlap with the plurality of grating structures 1160 such that the transition structure 1170 has segments that are arranged between adjacent pairs of the grating structures 1160. A cavity 1190 may be formed in the substrate 105 adjacent to the edge coupler. The cavity 1190 may include a portion that extends as an undercut region beneath the dielectric layer 107 such that all or a portion of the edge coupler is suspended on the dielectric layer 107 over the undercut region. The undercut region of the cavity 1190 may function to reduce light loss to the substrate 105. The edge coupler may be configured to receive light in a propagation direction along the longitudinal axis 112 of the metamaterial structure 115.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A structure for a photonics chip, comprising:
a substrate;
an optical component over the substrate, the optical component including a metamaterial structure, wherein the metamaterial structure includes:
a plurality of elements in series, each element having a first end surface and a second end surface opposite to the first end surface, wherein the second end surface of each element includes a first end surface portion and a second end surface portion along a lateral position on the second end surface, the second end surface portion having a different orientation from the first end surface portion; and
a dielectric material surrounding the plurality of elements.

2. The structure of claim 1, wherein each element of the metamaterial structure includes a first side surface and a second side surface opposite to the first side surface, the first side surface and the second side surface each connects the first end surface to the second end surface.

3. The structure of claim 2, wherein the second end surface portion of each element defines a protrusion in the second end surface of the element.

4. The structure of claim 3, wherein the second end surface portion of each element is curved in a convex shape relative to the first end surface portion in the second end surface.

5. The structure of claim 2, wherein the second end surface portion of each element defines a notch in the second end surface of the element.

6. The structure of claim 5, wherein for each pair of immediately adjacent elements of the plurality of elements of the metamaterial structure, the second end surface of a first element of the pair is configured to transfer light to the first end surface of a second element of the pair.

7. The structure of claim 1, wherein the second end surface of each element further includes a third end surface portion adjoining the second end surface portion, a fourth end surface portion adjoining the third end surface portion, and a fifth end surface portion adjoining the fourth end surface portion, wherein the second end surface portion, the third end surface portion and the fourth end surface portion define a protrusion relative to the first end surface portion and the fifth end surface portion in the second end surface.

8. The structure of claim 7, wherein the second end surface portion and the fourth end surface portion of the second end surface are planar.

9. The structure of claim 7, wherein the third end surface portion of the second end surface is planar and oriented at right angles to the second end surface portion and the fourth end surface portion of the second end surface.

10. The structure of claim 7, wherein the first end surface of each element of the metamaterial structure is substantially flat.

11. The structure of claim 7, wherein the first end surface of each element further includes a notch in the first end surface.

12. The structure of claim 7, wherein the first end surface of each element further includes a first end surface portion adjoining a second end surface portion and the second end surface portion adjoining a third end surface portion, wherein the first end surface portion, the second end surface portion and the third end surface portion define a notch in the first end surface.

13. The structure of claim 7, wherein the plurality of elements are spaced apart by a plurality of gaps and the dielectric material is disposed in the plurality of gaps.

14. The structure of claim 13, wherein respective spacing of the gaps between the elements are configured to decrease gradually in a direction of light propagation such that the protrusion in the second end surface of a preceding element of a pair of elements physically contacts the first end surface of a succeeding element of the pair.

15. The structure of claim 1, wherein the second end surface of each element further includes a third end surface portion adjoining the second end surface portion and a fourth end surface portion adjoining the third end surface portion, wherein the second end surface portion, the third end surface portion and the fourth end surface portion define a notch in the second end surface.

16. The structure of claim 15, wherein the second end surface portion and the fourth end surface portion of the second end surface are planar.

17. The structure of claim 16, wherein the third end surface portion of the second end surface is planar and oriented at right angles to the second end surface portion and the fourth end surface portion of the second end surface.

18. The structure of claim 15, wherein each element includes opposing first side surface and second side surface, the first side surface and the second side surface each connects the first end surface to the second end surface, a first prong between the respective notch and the first side surface and a second prong between the respective notch and the second side surface.

19. The structure of claim 1, wherein the plurality of elements are aligned to a longitudinal axis of the metamaterial structure.

20. A method, comprising:
forming an optical component over a substrate, the optical component including a metamaterial structure, wherein forming the metamaterial structure includes:
forming a plurality of elements in series, each element having a first end surface and a second end surface opposite to the first end surface, wherein the second end surface of each element includes a first end surface portion and a second end surface portion along a lateral position on the second end surface, the second end surface portion having a different orientation from the first end surface portion; and
forming a dielectric material surrounding the plurality of elements.
